(19) United States
(12) Patent Application Publication
(10) Pub. No.: US 2023/0297028 A1
(43) Pub. Date: Sep. 21, 2023

(54) Mechanical Watch

(71) Applicant: Flexous Mechanisms IP B.V., Delft (NL)

(72) Inventors: Maarten Pieter Lustig, Delft (NL); Sybren Lennard Weeke, Delft (NL); Eola Jessica Giuffre, Delft (NL); Roemer Michiel Helwig, Delft (NL); Nima Tolou, Delft (NL); Johannes Wilhelmus Benjamin Spruit, Delft (NL); Robin Mak, Delft (NL)

(21) Appl. No.: 17/695,427

(22) Filed: Mar. 15, 2022

(51) Int. Cl. G04B 17/04; G04B 18/02

(52) U.S. Cl. CPC G04B 17/045; G04B 18/02

(57) ABSTRACT

A mechanical watch including an in-plane oscillator (1) with a tuning mass (2), the oscillator (1) including a receptacle (3) for the tuning mass (2), the tuning mass (2) having a first portion (2′) snugly fitting in the receptacle (3), a second portion (2″) with a thickness that is equal or substantially equal to a thickness of the first portion (2′), and a length as seen at right angles with reference to said thickness that is substantially greater than said thickness so as to provide that the tuning mass (2) is substantially planar and extends outside the receptacle (3) in a plane substantially perpendicular to the plane of the oscillator (1).

### BACKGROUND OF THE INVENTION

### Field of the Invention

Embodiments of the present invention relate to a mechanical watch comprising an oscillator provided with a tuning mass, wherein the oscillator comprises a receptacle for the tuning mass.

### Background Art

EP-A-2 410 386 and JP 2016/164544 each disclose a mechanical watch and tuning mass, wherein the tuning mass is embodied as an insert mounted in a receptacle of the oscillator for adjusting its inertia and/or its balance and/or its oscillation frequency.

In particular when the oscillator and tuning mass of the mechanical watch are of relatively brittle material, the problem may occur that the tuning mass is not well kept in the receptacle of the oscillator, and that the construction is vulnerable and may easily break when subjected to shocks. This is of course not acceptable in a high quality and expensive mechanical watch, which is made to endure for decades, if not generations to come.

In order to address the problem of limited plastic deformability when particular parts of the mechanical watch are made of fragile material, EP 3 955 064 proposes a timepiece component comprising an element in the form of a perforated plate which is produced in a single piece of said fragile material and which comprises an opening intended for receiving a pin. The perforated plate comprises a connecting part and an elastic part, the connecting part being equipped for receiving the pin, and the elastic part having a plurality of internal notches and a plurality of external notches, the internal notches and the external notches being arranged alternately, so that a section of the elastic part which is delimited on either side by two outer notches always contains an inner notch, and vice versa.

A problem with this known timepiece is that notches can be very difficult or impossible to make at high resolution when using the known DRIE manufacturing process. Besides, notches have discrete positions and thus provide lower resolution.

Discussion of the references referenced herein is given for more complete background and is not to be construed as an admission that such publications are prior art for patentability determination purposes.

### BRIEF SUMMARY OF THE INVENTION

It is therefore an object of the invention to provide a notch-free solution which offers higher resolution and better real world implementation, in particular to provide the timepiece with improved shock resistance and to reliably maintain the oscillator frequency.

It is a further object of the invention to make fine tuning of the oscillator easier, and to provide a mechanical watch with increased versatility, which is suitable for carefree fine tuning of the oscillator, and that the oscillator is well-equipped to be moderated into working at slightly differing frequencies.

It is still a further object of the invention to answer to the requirements of unprecedented accuracy in tuning such a mechanical watch.

Embodiments of the present invention are directed to a mechanical watch comprising the features of the the appended claims.

In a first aspect of the invention, a mechanical watch comprises an oscillator provided with a tuning mass, wherein the oscillator comprises a receptacle for the tuning mass, and wherein one of the oscillator and the tuning mass is provided with at least one flexure for clamping the oscillator and the tuning mass together. In this construction it is possible to provide a reliable fit of the tuning mass to the oscillator which is furthermore to a large extent shock resistant.

The reliability of the fit and the shock resistance of the connection between the oscillator and the tuning mass may further be improved by providing the mechanical watch with plural flexures for clamping the oscillator and the tuning mass together.

It is possible to provide the connection between the tuning mass and the oscillator is several ways. In one embodiment the flexure or flexures are provided on the tuning mass. The flexures are then either on one side or on opposite sides of the tuning mass.

In another alternative embodiment, the flexure or flexures are provided in or adjacent to the receptacle of the oscillator. Again, different embodiments are feasible. In one embodiment the flexure or flexures are unilaterally on one side of the receptacle for the tuning mass. In an additional or alternative and more preferable embodiment which provides further increased shock resistance, the flexures are provided on opposite sides of the receptacle for the tuning mass.

In some embodiments, particularly when the oscillator is circular, each flexure that is at a greater distance from the receptacle than another flexure that is closer to the receptacle, is shorter than the flexure that is closer to the receptacle. Further each flexure that is at a greater distance from the receptacle than another flexure that is closer to the receptacle has a smaller width than the flexure that is closer to the receptacle. This is however not essential to the invention. In other embodiments all flexures may have the same length and width, or may differ from each other in other aspects.

The benefits of the invention are in particular achieved in a mechanical watch wherein the oscillator and the flexure or flexures are monolithic. In particular this applies when the oscillator and the flexure or flexures are made of silicon. The tuning mass is made of a heavier material, in particular metal, preferably gold or platina.

When multiple flexures are provided in or adjacent to the receptacle for the tuning mass, all flexures positioned at a same side of the receptacle are engaging a neighbouring flexure so as to contribute to a clamping force applied to the tuning mass received in the receptacle.

It is further preferred that the flexure or flexures engaging the tuning mass are embodied with a receiving part for the tuning mass that is shaped so as to secure a stable position of the tuning mass in said receiving part of the flexure or flexures.

A preferential embodiment of the tuning mass is to equip the tuning mass with a first portion snugly fitting in the receptacle, and a second portion with a thickness that is equal or substantially equal to a thickness of the first portion, and a length as seen at right angles with reference to said thickness that is substantially greater than said thickness so as to provide that the tuning mass is substantially planar and extends outside the receptacle in a plane substantially perpendicular to the plane of the oscillator.

To promote the ease and accuracy of fine-tuning it is preferable that the length/thickness ratio of the second portion is at least 4:1; preferably 5:1.

For manufacturing the tuning mass with an accurate weight distribution, it is preferred that the tuning mass is monolithic.

Preferably the first portion of the tuning mass is positioned eccentrically with reference to the second portion of the tuning mass. This makes tuning possible by simply changing the orientation of the second portion of the tuning mass with reference to the oscillator. This is particularly promoted by arranging that the first portion of the tuning mass is positioned eccentrically with reference to a center of gravity of the second portion of the tuning mass.

The objectives of the invention are further promoted by arranging that the second portion is equipped with a lever extending away from the first portion, wherein the first portion is snugly yet rotatably fitting in the receptacle.

It is preferred that the lever is equipped with an extremity distant from the first portion, which extremity has a larger distance with respect to the plane of the oscillator than the remainder of the lever. Handling the lever for rotating it with reference to the oscillator is then further simplified.

It is then preferable that the remainder of the lever between the first portion and the extremity engages the oscillator so as to avoid undesirable vibrations during operation of the watch.

For particularly accurate results and to promote shock-resistance it is preferred that the oscillator comprises at least two receptacles, each receptacle equipped to receive a tuning mass.

The results can be further enhanced by securing that the at least two receptacles are regularly distributed in the oscillator.

In another aspect of the invention, the tuning mass is one from a series of tuning masses, wherein each individual tuning mass in the series of tuning masses has a weight that differs from the other individual tuning masses in said series of tuning masses.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 shows schematically an oscillator of a mechanical watch with two tuning masses according to an embodiment of the present invention in two different isometric views;

FIG. 2 shows a first embodiment of a tuning mass according to an embodiment of the present invention;

FIGS. 3A/3B show two different tuning masses from a series of tuning masses according to an embodiment of the present invention;

FIG. 4 shows both in an isometric view and in a side view a second embodiment of a tuning mass according to an embodiment of the present invention;

FIG. 5 shows a side view of still another embodiment of a tuning mass according to an embodiment of the present invention;

FIG. 6 shows a tuning mass which is provided with one flexure for clamping the oscillator and the tuning mass together according to an embodiment of the present invention;

FIG. 7 shows a tuning mass which is provided with multiple flexures for clamping the oscillator and the tuning mass together according to an embodiment of the present invention;

FIG. 8 shows a cross-sectional view of an oscillator provided with a single flexure adjacent to a receptacle of the oscillator to clamp the tuning mass according to an embodiment of the present invention;

FIG. 9 shows a cross-sectional view of an oscillator provided with multiple flexures adjacent to a receptacle of the oscillator to clamp the tuning mass according to an embodiment of the present invention; and

FIG. 10 shows a cross-sectional view of an oscillator provided with multiple flexures on opposite sides of a receptacle equipped to clampingly receive a tuning mass according to an embodiment of the present invention.

Whenever in the figures the same reference numerals are applied, these numerals refer to the same or similar parts.

### DETAILED DESCRIPTION OF THE INVENTION

The general construction of a mechanical watch is known to the skilled person, therefore the figures concentrate on the features of the mechanical watch of the invention without showing elements of the mechanical watch that are not relevant for understanding the invention.

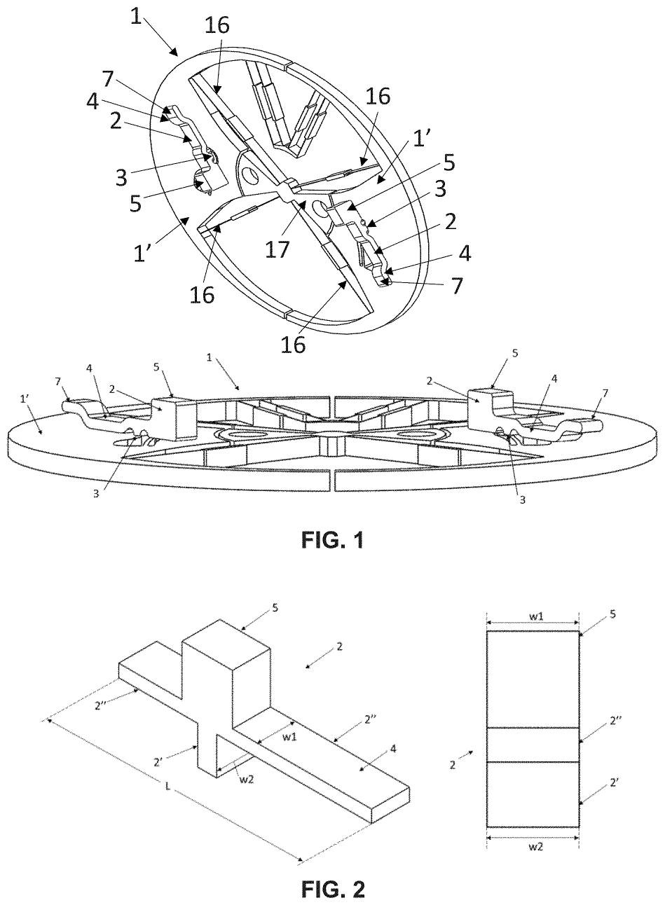

A mechanical watch according to the invention comprises an oscillator 1 as is shown in FIG. 1. FIG. 1 also depicts that the oscillator 1 comprises two tuning masses 2, however this is not essential. The oscillator should be provided with at least one tuning mass 2. The two tuning masses 2 applied to the oscillator 1 of FIG. 1 are preferably provided at diametrically opposite positions. The tuning masses 2 are additional masses to tune the —in this embodiment—two vibratory masses 1′ of the oscillator 1 to a desired vibrating frequency. The two vibratory masses 1′ are connected through resilient suspension arms 16 with a frame 17 of the oscillator 1, which frame 17 represents ground. The resilient suspension arms 16, the frame 17 and the vibratory masses 1′ are monolithic.

A very basic embodiment of the tuning mass 2 is shown in FIG. 2. FIG. 2 shows that the tuning mass 2 is equipped with a first portion 2′ and a second portion 2″ which extends at a substantially right angle with reference to the first portion 2′. The second portion 2″ has a thickness W1 that is equal or substantially equal to a thickness W2 of the first portion 2′, and a length L as seen at right angles with reference to said thickness W1 that is substantially greater than said thickness W1 so as to provide that the tuning mass 2 is substantially planar. The length/thickness ratio of the second portion 2″ is at least 4:1; preferably 5:1. It is further preferable that the tuning mass 2 is monolithic.

It further shows that the first portion 2′ of the tuning mass 2 is positioned eccentrically with reference to the second portion 2″ of the tuning mass 2. Preferably this is arranged such that the first portion 2′ of the tuning mass 2 is positioned eccentrically with reference to a center of gravity of the second portion 2″ of the tuning mass 2.

The first portion 2′ of the tuning mass 2 is snugly fitting in a receptacle 3 of the oscillator 1 as is depicted in FIG. 1, wherein one thing and another is arranged such that the second portion 2″ is equipped with a lever 4 extending away from the first portion 2′, wherein the first portion 2′ is snugly yet rotatably fitting in the receptacle 3 of the oscillator 1.

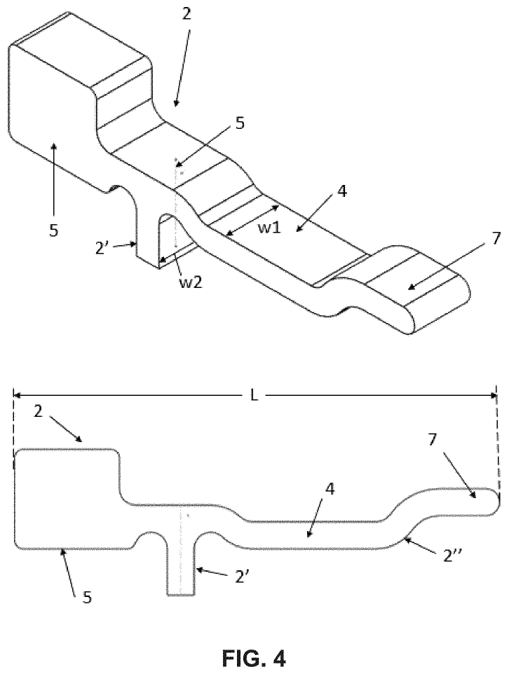

Making now reference to FIG. 4, some other features can be elucidated that are to be noted in relation to the oscillator 1 shown in FIG. 1. As already mentioned FIG. 1 shows the oscillator 1 provided with two tuning masses 2. The embodiment of the tuning masses 2 that are applied in FIG. 1, is also shown in FIG. 4, and from the combination of FIG. 1 with FIG. 4 it is clear that apart from the first portion 2′ that snugly and rotatably fits in the receptacle 3 of the oscillator 1, (the plane of) the substantially planar tuning mass 2 extends outside the receptacle 3 in a plane substantially perpendicular to the plane of the oscillator 1.

As is best shown in FIG. 4 the lever 4 is equipped with an extremity 7 distant from the first portion 2′, which extremity 7 has a larger distance with respect to the plane of the oscillator 1 than the remainder of the lever 4. This makes handling of the lever 4 easy. It is further preferable that the remainder of the lever 4 between the first portion 2′ and the extremity 7 engages the oscillator 1.

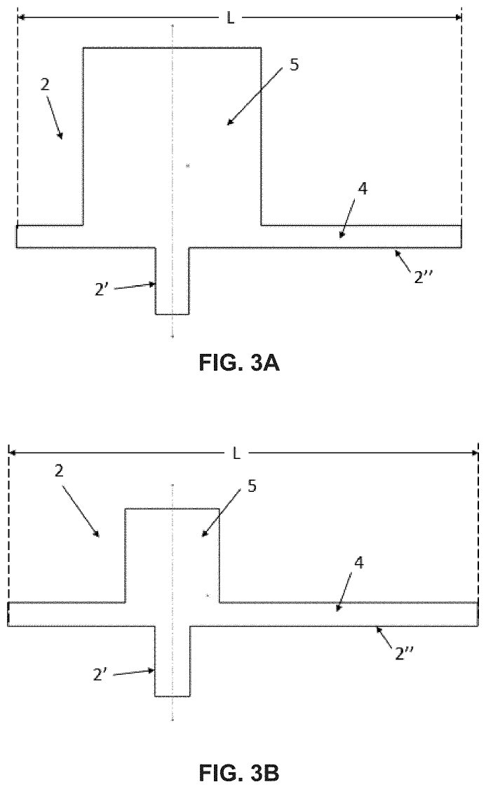

FIGS. 1 and 2 show that the second portion 2″ can be equipped with a body 5. FIG. 3A and FIG. 3B show another feature of the invention, notably that the figures show two different tuning masses 2 that form part of a series of tuning masses, wherein regarding the two different tuning masses 2 that are shown in these FIGS. 3A/3B it can be remarked that the weight percentage of the body 5 in the tuning mass 2 of FIG. 3A is higher than the weight percentage of the body 5 in the tuning mass 2 of FIG. 3B. FIGS. 3A/3B thus depict as an example that each tuning mass 2 is one from a series of tuning masses, wherein each individual tuning mass 2 in the series of tuning masses has a weight that differs from the other individual tuning masses in said series of tuning masses. For the avoidance of doubt it is remarked that it is not required to apply a separate body 5 in such tuning masses. The important thing is that the tuning mass in total has a particular predefined mass, and that a series of such tuning masses are provided in a range of consecutive weights.

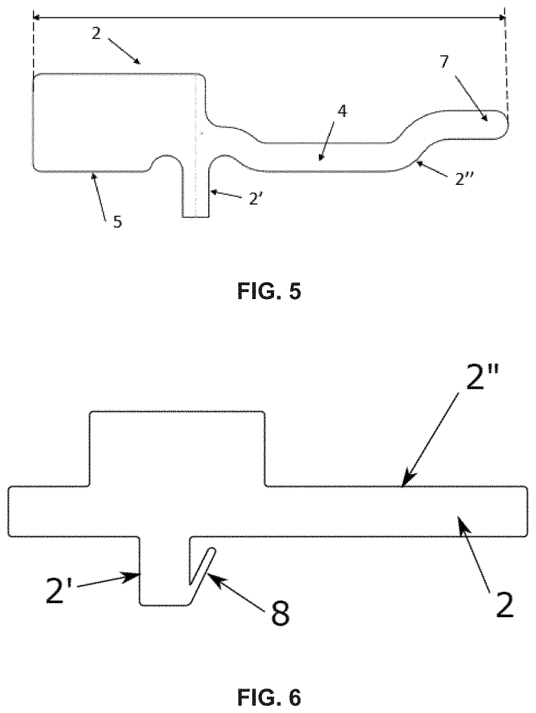

FIG. 4 and FIG. 5 show embodiments of the tuning mass 2 wherein the body 5 is provided at a side of the first portion 2′ which is opposite to the lever 4. This is however not essential; the body could also be on the same side as the lever.

In FIG. 5 the body 5 of the tuning mass 2 comprises a higher weight percentage of the tuning mass 2 than the body 5 of the tuning mass 2 shown in FIG. 4. The embodiments of FIGS. 4 and 5 not only differ from the embodiments of FIG. 3A/3B in that in FIGS. 4 and 5 the body 5 is provided at a side of the first portion 2′ which is opposite to the lever 4, but also in that the lever 4 is equipped with an extremity 7 distant from the first portion 2′, which extremity 7 has a larger distance with respect to the plane of the oscillator 1 than the remainder of the lever 4.

For properly and securely attaching the tuning mass 2 to the oscillator 1, reference is now made to FIGS. 6-10.

In FIG. 6 it is shown that the tuning mass 2 is provided with one flexure 8 for clamping the oscillator 1 and the tuning mass 2 together. This flexure 8 is provided on the first portion 2′ of the tuning mass 2 which is intended to be inserted into the receptacle 3 of the oscillator 1. It is of course also possible to provide such a flexure in or adjacent the receptacle 3 of the oscillator 1 to provide a reliable attachment of the tuning mass 2 to the oscillator 1. This will be discussed hereinafter with reference to FIGS. 8-10.

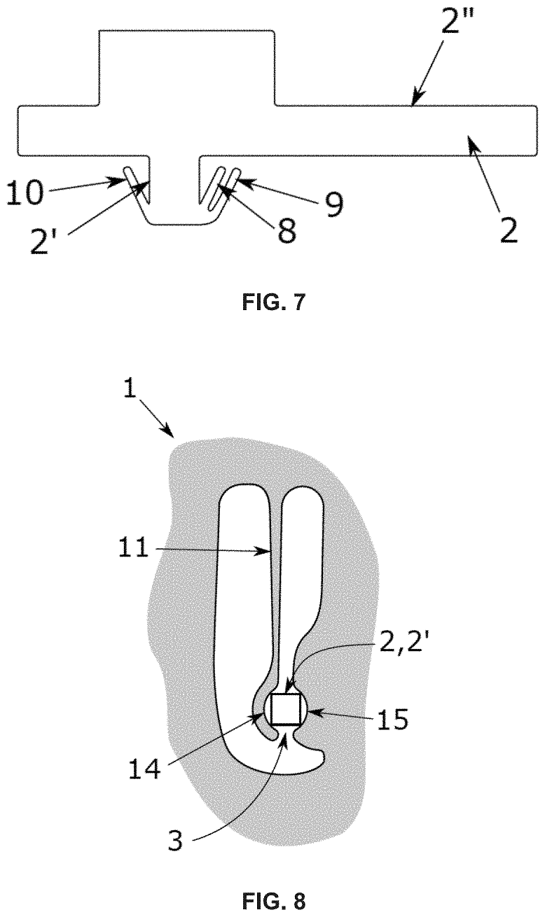

In FIG. 7 a different embodiment is shown wherein there are multiple flexures 8, 9, 10 provided on the first portion 2′ of the tuning mass 2. Again it is also possible to provide such a plurality of flexures in or adjacent to the receptacle 3 of the oscillator 1 for clamping the first portion 2′ of the tuning mass 2 therein.

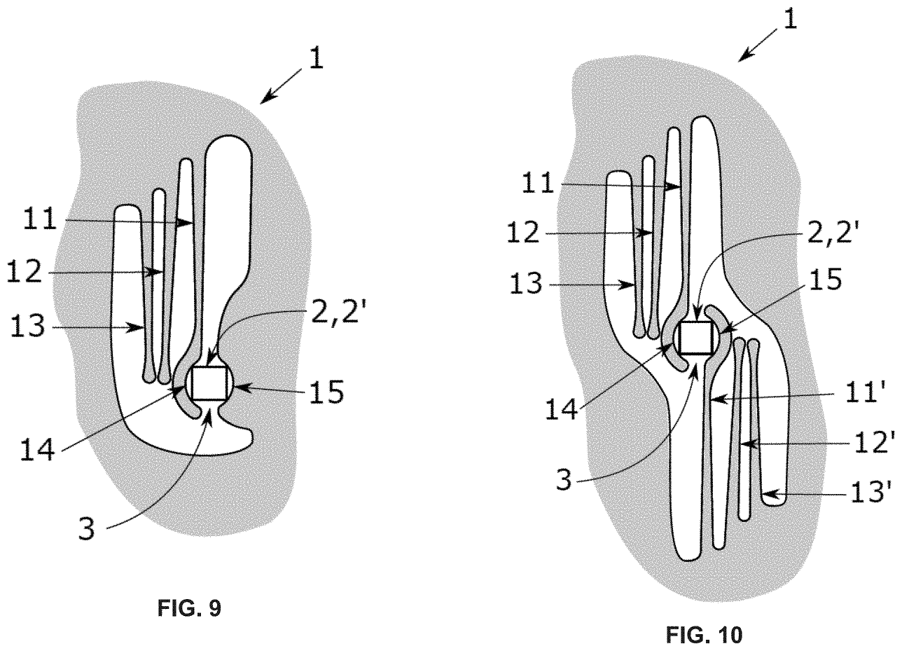

In FIG. 8 it is shown that a single flexure 11 is provided adjacent to the receptacle 3 of the oscillator 1. FIG. 9 shows that there are plural flexures 11, 12, 13 adjacent to the receptacle 3 of the oscillator 1, whereas FIG. 10 shows an embodiment wherein there are flexures 11, 12, 13, 11′, 12′, 13′ on opposite sides of the receptacle 3 for the tuning mass 2.

FIGS. 9 and 10 depict that in this shown embodiment each flexure that is at a greater distance from the receptacle 3 than another flexure that is closer to the receptacle 3 is shorter than the flexure that is closer to the receptacle 3. This is however not essential to the invention. The feature can be easily recognized in FIG. 9 wherein flexure 13 which is at the largest distance from the receptacle 3 is shorter than the closer to the receptacle 3 positioned flexure 12, which in turn is shorter than flexure 11, which is closest to the receptacle 3. The same applies for the series of flexures 11, 12 and 13 that are shown in FIG. 10 on the left of the receptacle 3, as well as the series of flexures 11′, 12′, 13′ that are shown in FIG. 10 on the right of the receptacle 3. Correspondingly each flexure that is at a greater distance from the receptacle 3 than another flexure that is closer to the receptacle 3 has a smaller width than the flexure that is closer to the receptacle 3. This is not further shown in the figures but is well understood by the skilled person considering the above explanation with regard to the length of the flexures. Also, this latter feature is not essential to the invention.

Preferably the oscillator 1 and the flexure or flexures 11, 12, 13 are monolithic. Desirably the oscillator 1 and the flexure or flexures 11, 12, 13 are made of silicon to benefit from the lack of susceptibility of this material for magnetic field lines. The tuning mass 2 is of metal, preferably gold or platina.

With reference to FIGS. 9 and 10 it is further shown that with multiple flexures provided in or adjacent to the receptacle 3 for the tuning mass 2, all flexures 11, 12, 13 resp. 11′, 12′, 13′ positioned at a same side of the receptacle 3 are engaging a neighbouring flexure so as to contribute to a clamping force applied to the tuning mass 2 received in the receptacle 3. In FIG. 9 this relates to flexure 12 engaging flexure 11, and flexure 13 engaging flexure 12. This is also shown in FIG. 10, wherein further flexure 12′ engages flexure 11′ and flexure 13′ engages flexure 12′.

In each of FIGS. 8-10 it is shown that the flexure or flexures 11, 11′ engaging the tuning mass 2 are embodied with a receiving part 14, 15 for the tuning mass 2 that is shaped so as to secure a stable position of the tuning mass 2 in said receiving part 14, 15 of the flexure or flexures.

The construction according to the invention makes it possible that the tuning mass and the oscillator can be securely and reliably connected to each other, whilst maintaining a high shock resistance capability.

Embodiments of the present invention can include every combination of features that are disclosed herein independently from each other. Although the invention has been discussed in the foregoing with reference to exemplary embodiments of the mechanical watch of the invention, the invention is not restricted to these particular embodiments which can be varied in many ways without departing from the invention. The discussed exemplary embodiments shall therefore not be used to construe the appended claims strictly in accordance therewith. On the contrary the embodiments are merely intended to explain the wording of the appended claims without intent to limit the claims to these exemplary embodiments. The scope of protection of the invention shall therefore be construed in accordance with the appended claims only, wherein a possible ambiguity in the wording of the claims shall be resolved using these exemplary embodiments.

Although the invention has been described in detail with particular reference to the disclosed embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguration of their relationships with one another.

What is claimed is:

1. A mechanical watch comprising:
an oscillator comprising a tuning mass, wherein the oscillator comprises a receptacle for the tuning mass, and said oscillator is of a type wherein vibratory masses of the oscillator are movably connected with resilient suspension arms to a frame of the oscillator, and wherein the vibratory masses, the frame and the resilient suspension arms are monolithic, and wherein one of the oscillator and the tuning mass comprises at least one flexure for clamping the oscillator and the tuning mass together.

2. The mechanical watch according to claim 1, further comprising plural flexures for clamping the oscillator and the tuning mass together.

3. The mechanical watch according to claim 1, wherein the flexure or flexures are disposed on the tuning mass.

4. The mechanical watch according to claim 3, comprising flexures on opposite sides of the tuning mass.

5. The mechanical watch according to claim 1, wherein the flexure or flexures are disposed in or adjacent to the receptacle of the oscillator.

6. The mechanical watch according to claim 5, comprising flexures on opposite sides of the receptacle for the tuning mass.

7. The mechanical watch according to claim 5, wherein each flexure that is at a greater distance from the receptacle than another flexure that is closer to the receptacle is shorter than the flexure that is closer to the receptacle.

8. The mechanical watch according to claim 5, wherein each flexure that is at a greater distance from the receptacle than another flexure that is closer to the receptacle has a smaller width than the flexure that is closer to the receptacle.

9. The mechanical watch according to claim 1, wherein the oscillator and the flexure or flexures are monolithic.

10. The mechanical watch according to claim 1, wherein the oscillator and the flexure or flexures comprise silicon, and the tuning mass comprises metal.

11. The mechanical watch according to claim 5, wherein with multiple flexures disposed in or adjacent to the receptacle for the tuning mass, all flexures positioned at a same side of the receptacle are engaging a neighbouring flexure so as to contribute to a clamping force applied to the tuning mass received in the receptacle.

12. The mechanical watch according to claim 1, wherein the flexure or flexures engaging the tuning mass comprise a receiving part for the tuning mass that is shaped so as to secure a stable position of the tuning mass in said receiving part of the flexure or flexures.

13. The mechanical watch according to claim 1, wherein the tuning mass comprises a first portion snugly fitting in the receptacle, and a second portion with a thickness that is equal or substantially equal to a thickness of the first portion, and a length as seen at right angles with reference to said thickness that is substantially greater than said thickness so as to provide that the tuning mass is substantially planar and extends outside the receptacle in a plane substantially perpendicular to the plane of the oscillator.

14. The mechanical watch according to claim 13, wherein the length/thickness ratio of the second portion is at least 4:1, and preferably 5:1.

15. The mechanical watch according to claim 13, wherein the first portion of the tuning mass is positioned eccentrically with reference to the second portion of the tuning mass.

16. The mechanical watch according to claim 13, wherein the first portion of the tuning mass is positioned eccentrically with reference to a center of gravity of the second portion of the tuning mass.

17. The mechanical watch according to claim 13, wherein the second portion comprises a lever extending away from the first portion, wherein the first portion is snugly yet rotatably fitting in the receptacle of the oscillator.

18. The mechanical watch according to claim 17, wherein the lever comprises an extremity distant from the first portion, which extremity has a larger distance with respect to the plane of the oscillator than the remainder of the lever.

19. The mechanical watch according to claim 18, wherein the remainder of the lever between the first portion and the extremity engages the oscillator.

20. The mechanical watch according to claim 1, wherein the oscillator comprises at least two receptacles, each receptacle equipped to receive a separate tuning mass.

21. The mechanical watch according to claim 20, wherein the oscillator is an in-plane oscillator and at least two receptacles are regularly distributed in the in-plane oscillator.

22. The mechanical watch according to claim 1, wherein the tuning mass is one of a series of tuning masses, wherein each individual tuning mass in the series of tuning masses has a weight that differs from the other individual tuning masses in said series of tuning masses.
